(19) United States
(12) Patent Application Publication
(10) Pub. No.: US 2023/0251459 A1
(43) Pub. Date: Aug. 10, 2023

(54) FASTENER FOR A MOTORCYCLE HANDLEBAR MIRROR

(71) Applicant: Rhino Motorcycle Products, LLC, San Jose, CA (US)

(72) Inventor: Steffen Hagene, San Jose, CA (US)

(21) Appl. No.: 17/650,341

(22) Filed: Feb. 8, 2022

(51) Int. Cl. G02B 7/182; B62J 29/00

(52) U.S. Cl. CPC G02B 7/182; B62J 29/00; F16B 2/065

(57) ABSTRACT

A mirror mount for mounting a mirror to a handlebar is provided. The mirror mount has a groove part in a middle area of the mirror mount, where the groove part is attachable by a mirror assembly. The groove part resides on the outside of the handlebar. The inner portion of the mirror mount fits inside the handlebar. The mirror mount has an outer portion that is on the outside of the handlebar. The mirror mount has a specific location thereon where a point of physical contact can be made with the handlebar.

### TECHNICAL FIELD

The present disclosure relates to a fastener that secures a mirror assembly to a handlebar such as that of a motorcycle to avoid rotation of the mounted mirror during operation of the vehicle such as a motorcycle or similar.

### BACKGROUND

Presently, a fastener secures a mirror assembly to a vehicle handlebar or similar by the fastener locking with a weight that resides internally or predominantly internally of such handlebar or similar. As the vehicle operates, the internal weight may rotate within the handlebar or similar. When the internal weight rotates within the handlebar or similar, due to the bumpiness of the vehicle in operation or similar, the mirror that had been previously clamped onto the fastener also rotates. More specifically, if the fastener and the internal weight can rotate inside the bars at speed, the air pressure on the mirror takes the mirror out of position. A rotating mirror is considered to be undesirable or may be problematic while driving the vehicle, for example, for safety concerns of the driver being able to see other vehicles to the side or to the rear of their vehicle.

### SUMMARY

A mirror mount for mounting a mirror to a handlebar is provided. The mirror mount has a groove part in a middle area of the mirror mount, where the groove part is attachable by a mirror assembly. The groove part resides on the outside of the handlebar. The inner portion of the mirror mount fits inside the handlebar. The mirror mount has an outer portion that is on the outside of the handlebar. The mirror mount has a specific location thereon where a point of physical contact can be made with the handlebar.

### BRIEF DESCRIPTION OF THE DRAWINGS

FIG. 1 is a schematic diagram showing an exploded view of a fastener or mirror mount assembly, according to some embodiments of the disclosed technology;

FIG. 2 is a schematic diagram showing an assembled view of the fastener or mirror mount assembly, according to some embodiments of the disclosed technology;

FIG. 3 is a schematic diagram illustrating an assembly cross-section, according to some embodiments of the disclosed technology;

FIG. 4 is a schematic diagram illustrating an assembly cross-section zoomed in to the bar or mount interface, according to some embodiments of the disclosed technology;

FIG. 5 is a schematic diagram illustrating a recess in the mirror mount, according to some embodiments of the disclosed technology;

FIG. 6 is a schematic diagram illustrating an end view cross-section of the mirror mount, according to some embodiments of the disclosed technology;

FIG. 7A-C is a schematic diagram illustrating a wave washer and a toothed washer, according to some embodiments of the disclosed technology;

FIG. 8 is a schematic diagram illustrating sample mirrors to be mounted, according to the prior art; and

FIG. 9 is a schematic diagram illustrating a mirror mounted onto the innovative mirror mount, according to some embodiments of the disclosed technology.

### DETAILED DESCRIPTION

The present disclosure relates to a fastener or mirror mount that secures a mirror assembly to a handlebar such as a motorcycle to avoid rotation of the mounted mirror during operation of the vehicle such as a motorcycle or similar.

Some models of motorcycles, particularly sport bikes, use an internal weight system captive inside the bars. The weight is held into the bar with a clip, but the weight is free to rotate. If any accessories are secured to that weight they will also rotate and that may be undesirable depending on for what that device is used. The only way devices are currently able to be installed on these types of bars without rotating is to remove the weights and secure them inside the hollow tube that is left. One issue is that removing the weights requires some disassembly of the controls mounted on the handlebar (also referred to herein as bars). Removing the weights takes time and in a lot of cases exceeds the desire or mechanical ability of the person attempting the removal. An ideal solution would be a simple bolt-on procedure that allows the weights to remain in place but allows the device to be mounted without the possibility of rotation.

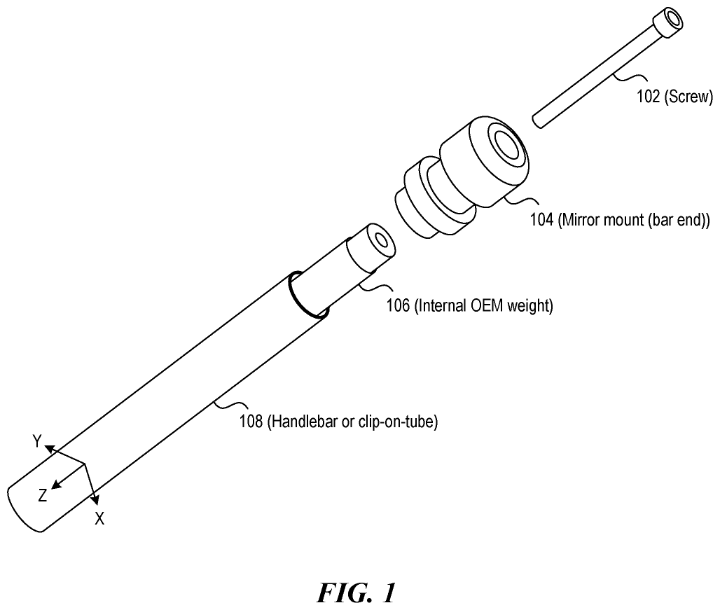

An embodiment may be understood with reference to FIG. 1, a schematic diagram showing an exploded view of a fastener or mirror mount assembly 100. The internal weight 106 is held into the bar 108 by a spring clip (not shown). There are also rubber grommets (not shown) on the weight to help keep it in place without vibrating. The grommets are in tight contact with the inside of the bar, but there is not enough friction to reliably prevent the weight from rotating. The mirror mount 104 (also referred to herein as the bar end) is held in place by a screw (102) passing through the bar end and threading in the weight. There are complimentary features on the weight and the bar end to keep them into relative position to each other, however the whole assembly will rotate if the bar end is rotated. Thus, improvements and solutions to these and other problems are outlined below in more detail.

In an embodiment, the assembly 100 includes an innovative fastener (“mirror mount”) 104, a handlebar or clip-on tube 108, an internal weight 106 that fits inside the handlebar 108 and a screw 102 that threads through the mirror mount 104 and the internal weight 106. It should be appreciated that the terms, fastener and mirror mount, may be used interchangeably herein. It should further be appreciated that the terms, handlebar or clip-on tube, may be used interchangeably herein.

In an embodiment, the mirror mount 104 is configured with a groove in a middle area to which a mirror assembly can be attached, such as clamped. That is, the mirror mount 104 is configured with the groove to accept the mirror assembly.

In an embodiment, such groove is machined or etched into the mirror mount 104. In an embodiment, the groove is circumferentially around the mirror mount 104, at about the middle of the body of mirror mount 104. The groove is wide enough to accept the mirror. In an embodiment, the groove is consistent across products, but not limited to such consistent sizes. For example, there are no standards for bracket widths, however currently there are two standards for the diameter of the bar the mirrors are made to clamp onto. It should be appreciated that most motorcycles use a ⅞″ (22 mm) outer diameter bar. There are also 1″ (28 mm) bars, but such bars typically are on types of vehicles (e.g., bikes) that do not use bar end mirrors, for example cruiser styles. Enterprises that make mirrors that do not open effectively all the way up commonly make their clamps to mount onto 1″ bars and then provide a plastic bushing to reduce the opening down to clamp onto ⅞″ bars. Embodiments herein can be configured for ⅞″ mirrors as some mirror manufacturers are already addressing the size differences.

In an embodiment, the mirror mount 104 is configured to have a larger diameter where the button is attached but where the rest of the mount stays at the smaller ⅞″ diameter. In this configuration, the mirror may be installed to the mount before being mounted to the motorcycle as an assembly. In another embodiment, a secondary ring may be added to the mount so that once the mount is assembled, it looks like the previous embodiment discussed above. It should be appreciated that these two embodiments are configured to be used with mirrors that do not have brackets that open all of the way up.

In an embodiment, mirror mount 104 has an inner portion or a nipple part and an outer portion. The inner portion faces handlebar 108. The inner portion fits inside handlebar 108 and the outer portion is on the outside of the handlebar 108 providing a surface to which the mirror can be clamped, e.g., the groove part. It should be appreciated that internal weight 106 may reside entirely within handlebar 108 or may protrude out a little past the end of handlebar 108. An example length that internal weight 106 protrudes is, but is not limited to, around ¼′, but less than ½″, so that the interface may actually happen just outside the handlebar 108, but it could be inside the handlebar 108. It should be appreciated that the deep recess on the back side on the mirror mount is useful so that the mount does not contact the weight, only the bar. If the weight is inside the end of the bar then there is not a need for a recess. In accordance with this embodiment, the part of the mount that extends inside the bars is short enough that it does not hit the weight. Further, in an embodiment, the end of the mirror mount 104 that faces the internal weight 106 actually clears the internal weight 106. That is, mirror mount 104 does not actually physically contact internal weight 106. Consistent with embodiments herein, only the internal threads in the internal weight 106 are used. It is desirable for the mirror mount 104 not to touch internal weight 106 at all. This is one reason that mirror mount 104 does not twist as the vehicle, such as the motorcycle, picks up speed. Consistent with embodiments herein, there is an interface between the end of handlebar 108 and the inner edge of mirror mount 104. Put another way, mirror mount 104 is clamping to handlebar 108, which is why the mirror mount does not twist. Otherwise, once the mirror mount starts getting pressure on it, the internal weight can start rotating and break up the interface. Thus, in accordance with embodiments herein, the point of contact between the handlebar 108 and the mirror mount provides a mating surface or a butting surface that then holds the mirror in place.

In an embodiment, the mirror mount 104 is made of, but is not limited to being made of, steel or aluminum.

In an embodiment, internal weight 106 may be provided by the original equipment manufacturer (OEM). For example, those skilled in the art may readily recognize internal weight 106 as that provided by the American Honda Motor Co., Inc. (Torrence, Calif.) for Honda U.S. motorcycles. Other examples of such internal weights include but are not limited to those added to scooters, ATVs and snowmobiles. In an embodiment, the internal weight reduces the vibration that a person's hands feel when they are riding the vehicle. The internal weight 106 dampens the vibration.

In an embodiment, the internal weight 106 is configured to allow a suitable piece of rubber fit around it such that the friction of the rubber against the inside of the handlebar 108 reduces or stops the internal weight 106 from rotating.

In an embodiment, handlebar 108 may be provided by the original equipment manufacturer, as well. One skilled in the art will readily recognize that such handlebar may be a clip-on tube. Consistent with embodiments herein, a handlebar can be one long tube that extends the width of the motorcycle and provides places for both hands. Such tube is are usually clamped onto the upper steering clamp. Consistent with embodiments herein, a clip-on tube typically is a shorter assembly that clamps directly onto the fork tubes. Such arrangement allows for a lower hand position and a resulting rider position better suited for road racing. The tubes may or may not be separate from the clamps. A lot of times they are separate so that they are easily replaceable if they get damaged in a crash.

In an embodiment, screw 102 may be a standardized screw that is readily available at local hardware stores and the like. An examine of such screen is an M6 screw. M8 is another size that may be used in an adapter. In an embodiment, screw 102 may be provided along with the mirror mount 104 as a package. In another embodiment, screw 102 is provided by the manufacturer or provider of the internal weight 106. In accordance with embodiments herein, as the screw 102 is tightened, the mirror mount 104 clamps to the handlebar 108 end.

In an embodiment, the internal weight 106 is used as a large captive nut into which to thread screw 102. In this configuration, mirror mount 104 is forced against the end of the handlebar 108. In this embodiment, it is the friction between mirror mount 104 and the handlebar 108 that keeps the mirror mount 104 from rotating and thus keeps the mirror assembly from rotating.

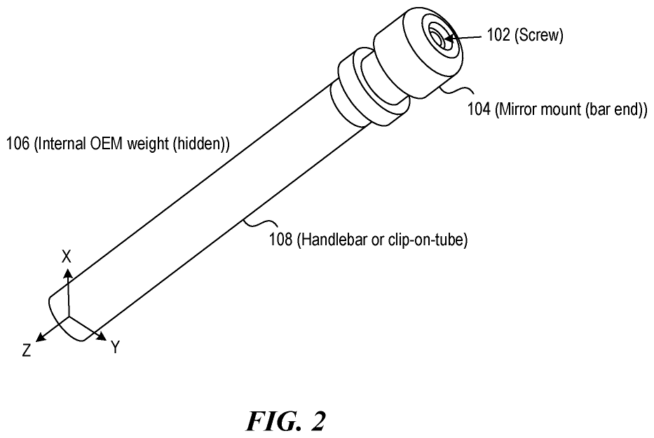

An embodiment may be understood with reference to FIG. 2, a schematic diagram showing an assembled view of the fastener or mirror mount assembly 200. The screw 102 is screwed into the mirror mount 104. The mirror mount 104 is attached or clamped to the handlebar 108. The internal weight 106 is inside the handlebar 106 or may protrude a bit outside the handlebar 108, however is out of view of the assembly 200.

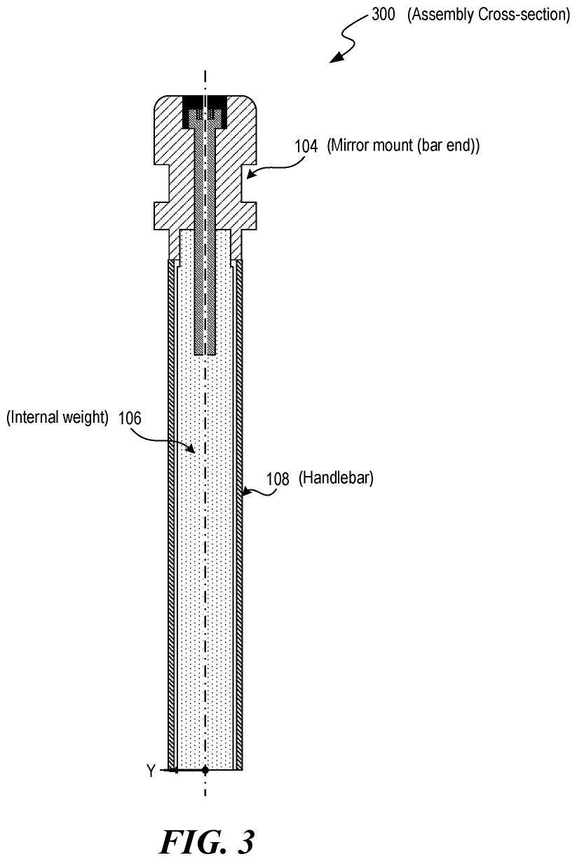

An embodiment may be understood with reference to FIG. 3, a schematic diagram illustrating an assembly cross-section 300. The illustration shows the groove in mirror mount 104. Further, the screw is shown screwed through the mirror mount 104 and into the internal weight 106, inside the handlebar 108.

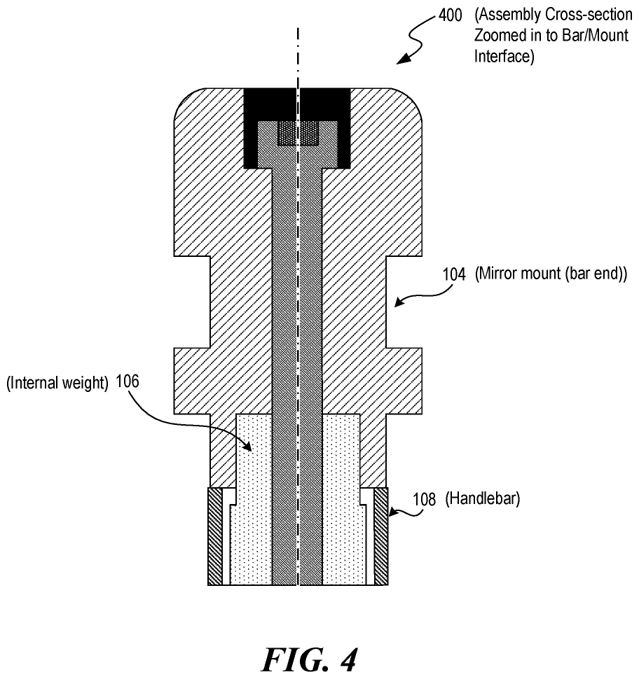

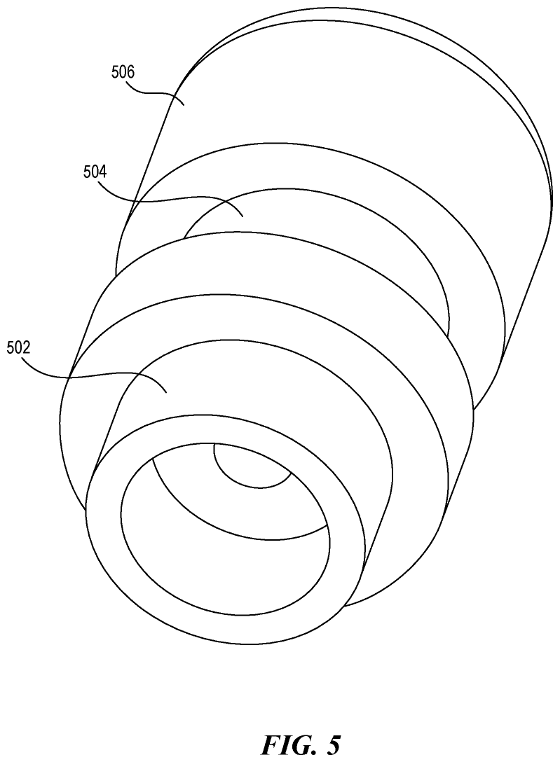

An embodiment may be understood with reference to FIG. 4, a schematic diagram illustrating an assembly cross-section 400 zoomed in to the handlebar and mirror mount 104 interface. The screw is shown screwed through the mirror mount 104 and into the internal weight 106, inside the handlebar 108. The illustration shows the groove part in mirror mount 104. The internal weight 106 is inside the handlebar 106 and is shown to protrude a bit outside the handlebar 108.

An embodiment may be understood with reference to FIG. 5, a schematic diagram illustrating the mirror mount 104 having a recess. The mirror mount 104 has an inner portion or a nipple part 502 and an outer portion 506, as described above. The inner portion 502 fits inside handlebar (e.g., handlebar 108) and the outer portion 506 is on the outside of the handlebar (e.g., handlebar 108) providing a surface to which the mirror can be clamped, e.g., the groove part 504.

In an embodiment, if the end of the weight extends past the end of the handlebar, the bar end will have a recess on the end closest to the weight to allow the weight to pass into the recess without contacting it, as depicted by 502. The recess in the bar end is larger than the diameter of the end of the weight so that this configuration helps align the bar end radially.

In an embodiment, if the end if the weight is deeper inside the handlebar and does not stick out past the end of the bar, the bar end may have a section sized close to the inner diameter of the handlebar so that the bar end fits inside the handlebar to align it radially. A recess in the bar end may or may not be needed to prevent contact with the weight, depending on how deep the weight is inside the handlebar.

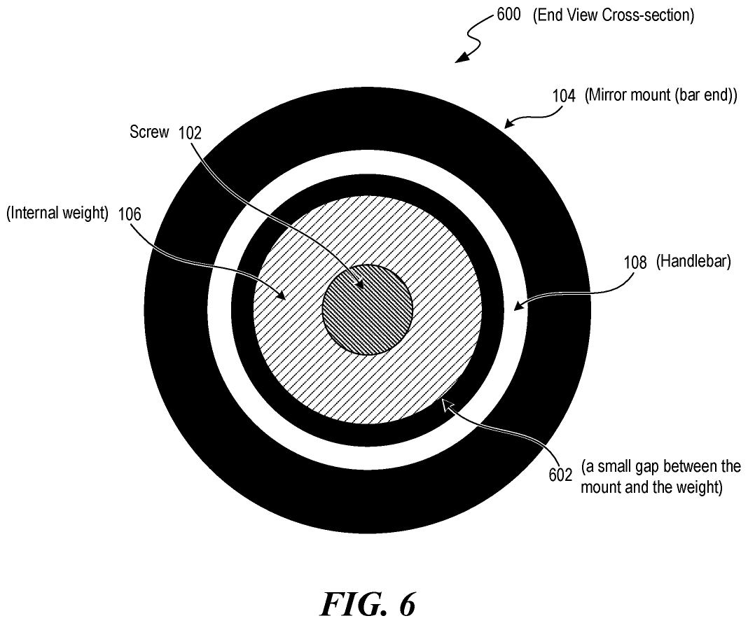

An embodiment may be understood with reference to FIG. 6, a schematic diagram illustrating an end view cross-section of the mirror mount assembly 600. The outer layer is the mirror mount 104. The next layer going inwards in the handlebar 108. This illustration depicts the friction between such mirror mount 104 and handlebar 108, so as to avoid any twisting of the mirror mount 104 and, thus, the mirror when clamped onto the mirror mount 104. After the handlebar 108 layer and proceeding inwards, a small gap 602 is illustrated. The gap 602 ensures that the handlebar 108 does not come into contact with the internal weight 106, which is the next inward layer after the gap. The innermost layer is the screw 102, which keeps the whole assembly intact.

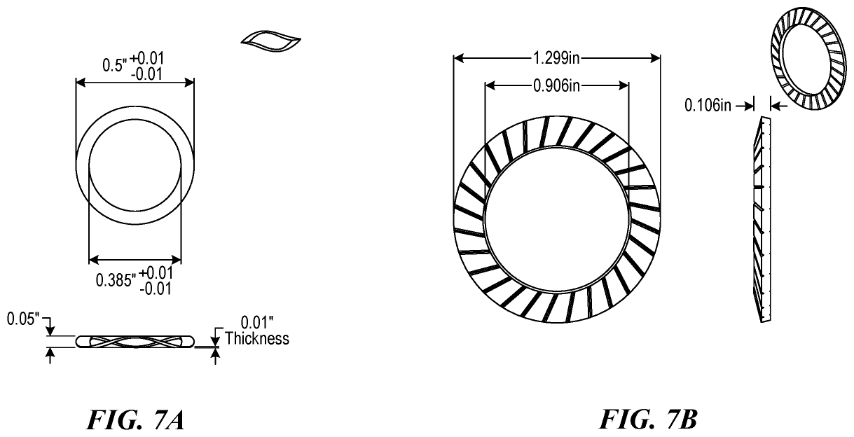

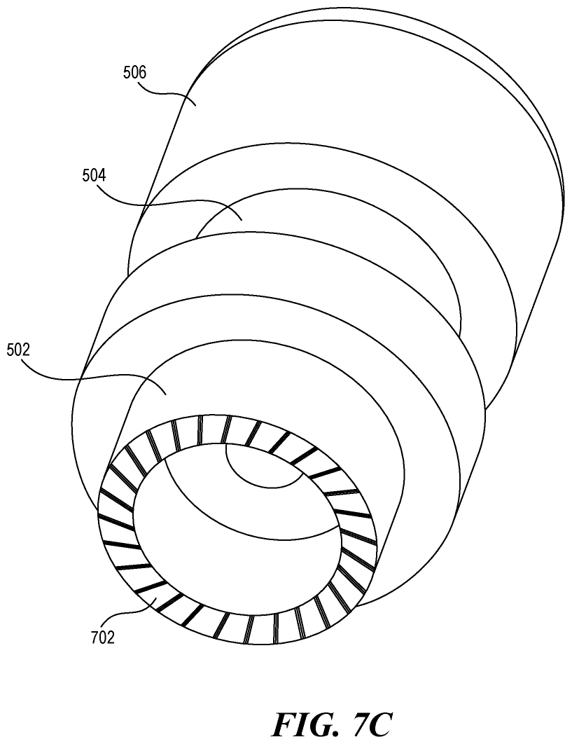

An embodiment may be understood with reference to FIG. 7A-C, schematic diagrams illustrating a wave washer (FIG. 7A) and a toothed washer (FIG. 7B). In an embodiment, features may be present on the end of the bar end that contacts the handlebar to help increase the resistance to rotation. Such features may be teeth or ridges, as in a toothed washer. In another embodiment, a wave spring or other separate hardware could be used between the handlebar and the bar end to lock the position of the bar end with respect to the handlebar. As an example consistent with an embodiment, the wave washer has dimensions 0.01-0.05 inches in thickness; 0.385 plus or minus 0.01 inches in width for the inner circumference; and 0.5 plus or minus 0.01 inches in width for the outer circumference. As another example consistent with an embodiment, the toothed washer has dimensions 0.106 inches in thickness; 0.906 inches in width for the inner circumference; and 1.299 inches in width for the outer circumference. FIG. 7C illustrates an embodiment in which the toothed washer (e.g., the toothed washer, ridges, or teeth from FIG. 7B) is drawn on, attached to, or embedded into the end of the bar end (e.g., that of FIG. 5) that contacts the handlebar to help increase the resistance to rotation. In an embodiment, the features of FIG. 7A and FIG. 7B can be machined into the mirror mount.

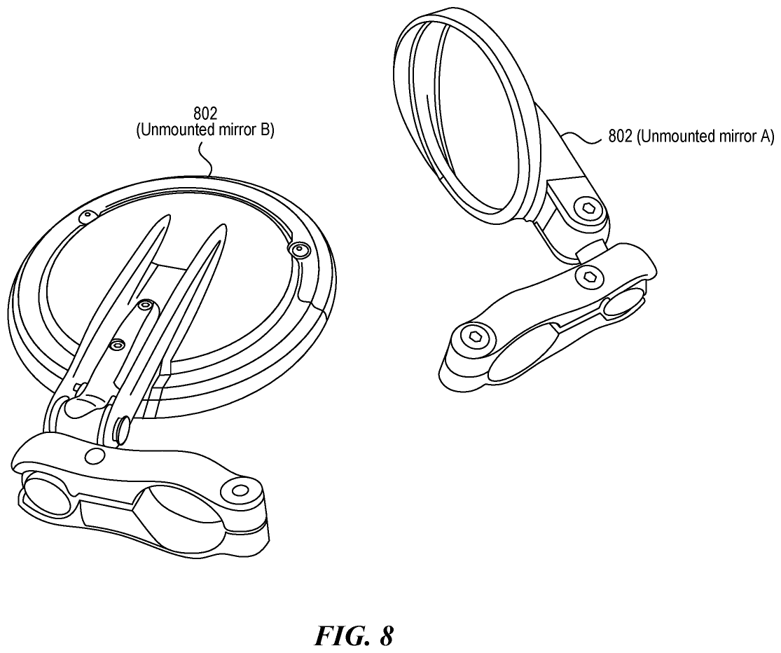

An embodiment may be understood with reference to FIG. 8, a schematic diagram illustrating sample mirrors to be mounted according to the prior art. The larger opening in the clamp is what goes into the groove of the mirror mount 104.

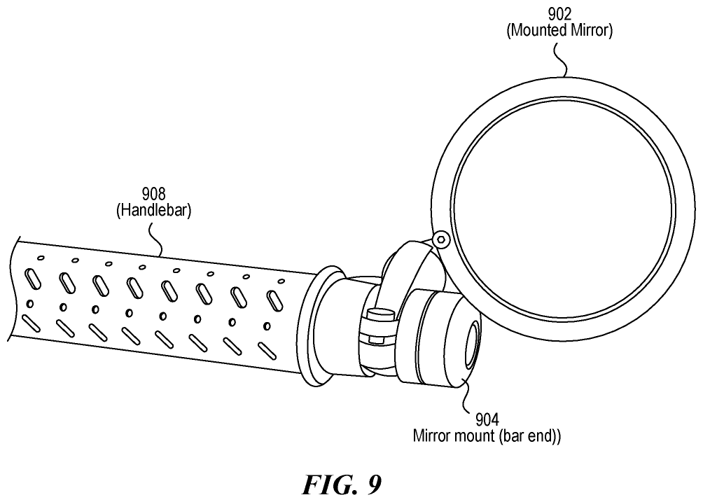

An embodiment may be understood with reference to FIG. 9, a schematic diagram illustrating a mirror mounted 902 onto the innovative mirror mount 904, which has clamped onto the handlebar 908. It should be appreciated that mirror mount 904 and handlebar 908 may be the same as shown in FIG. 1, e.g., 104 and 108, respectively, or may be a different instance of such items.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments.

Reference in this specification to “an embodiment” or “one embodiment” means that a particular feature, structure, or characteristic described in connection with the embodiment is included in at least one embodiment of the disclosure. The appearances of the phrase “in an embodiment” (or the like) in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

As used herein, the term “and/or” when used in the phrase “A and/or B” means “A, or B, or both A and B.” A similar manner of interpretation applies to the term “and/or” when used in a list of more than two terms.

From the foregoing, it will be appreciated that specific embodiments of the invention have been described herein for purposes of illustration, but that various modifications may be made without deviating from the scope of the invention. Accordingly, the invention is not limited except as by the appended claims.

What is claimed is:

1. A mirror mount for mounting a mirror to a tube, comprising:
a groove part in a middle area of the mirror mount, wherein the groove part is attachable by a mirror assembly, wherein the groove part is on the outside of the tube;
an inner portion that fits inside the tube;
an outer portion that is on the outside of the tube; and
a specific location point of physical contact with the tube.

2. The mirror mount of claim 1, wherein the tube is a handlebar or a clip-on.

3. The mirror mount of claim 1, wherein the groove part comprises a plurality of grooves that were previously machined in.

4. The mirror mount of claim 1, wherein the mirror mount is configured to be held in place by a screw passing through one end and threading in a weight.

5. The mirror mount of claim 4, wherein as the screw is tightened, the mirror mount clamps to the tube

6. The mirror mount of claim 1, wherein the mirror mount is made of steel or aluminum.

7. The mirror mount of claim 1, wherein the inner portion is configured to recess in the direction away from the tube in a way that the mirror mount does not contact a weight that resides in the tube.

8. The mirror mount of claim 1, wherein the part of the mirror mount that extends inside the tube is configured to be sufficiently short so that the mirror mount does not hit a weight in the tube.

9. The mirror mount of claim 1, wherein the inner portion that fits inside the tube is configured to make physical contact with the tube as a mating surface or as a butting surface to hold the mirror in place.

10. The mirror mount of claim 1, further comprising a button on the outer portion and away from the tube, wherein the diameter of the output portion is greater than ⅞″ and wherein the rest of the mirror mount is configured to be ⅞″.

11. The mirror mount of claim 1, further comprising a secondary ring so that once the mirror mount is assembled to the tube, the look of the mirror mount resembles other embodiments not requiring the secondary ring.

12. The mirror mount of claim 1, further comprising a wave washer on the end of the tube, the wave washer configured to contact the tube to help increase a resistance to rotation.

13. The mirror mount of claim 1, further comprising a toothed washer on the end of the tube, the toothed washer configured to contact the tube to help increase a resistance to rotation.

14. The mirror mount of claim 1, wherein the mirror mount is configured to work with a wave spring that resides between the tube and the mirror mount to lock a position of the mirror mount with respect to the tube.
